(19) United States
(12) Patent Application Publication
(10) Pub. No.: US 2005/0212975 A1
(43) Pub. Date: Sep. 29, 2005

(54) Television signal transmitter capable of reducing phase noise

(75) Inventor: Yasuharu Kudo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/087,276

(22) Filed: Mar. 22, 2005

(30) Foreign Application Priority Data
Mar. 26, 2004 (JP) 2004-092386

(51) Int. Cl. H04N 5/38

(52) U.S. Cl. 348/723

(57) ABSTRACT

A television signal transmitter containing: a first frequency conversion unit for up-converting a first intermediate frequency signal modulated by an image signal and a voice signal into a second intermediate frequency signal and a second frequency conversion unit for down-converting the second intermediate frequency signal into a television channel signal. The first frequency conversion unit is provided with a first local oscillating circuit and a first PLL circuit for controlling an oscillating frequency of the first local oscillating circuit. The second frequency conversion unit is provided with a second local oscillating circuit and a second PLL circuit for controlling an oscillating frequency of the second local oscillating circuit. The first PLL circuit and the second PLL circuit are constituted by fractional PLL circuits, respectively.

### BACKGROUND OF THE INVENTION

1. Field of the Invention

The present invention relates to a television signal transmitter suitable for a CATV system, etc.

2. Description of the Related Art

Referring to FIG. 3, a conventional television signal transmitter will be described. An image signal V and a voice signal S are input to an intermediate frequency circuit 41, and an intermediate frequency signal (a first intermediate frequency signal having a frequency of 45.75 MHz) modulated by the image signal V and voice signal S is output from the intermediate frequency circuit 41 to a first mixing circuit (mixer) 42. Here, the first intermediate frequency signal is mixed with an oscillating signal supplied from a first local oscillating circuit 43 and is then frequency-converted into a second intermediate frequency signal having a frequency of about 1.3 GHz. The first mixing circuit 42 and the first local oscillating circuit 43 constitute a first frequency converting circuit 44.

The second intermediate frequency signal output from the first mixing circuit 42 passes through a band pass filter 45 having a predetermined bandwidth (approximately 6 MHz), then is amplified to a predetermined level by a second intermediate frequency amplifying circuit 46, and then is input to a second mixing circuit 47. In the second mixing circuit 47, the second intermediate frequency signal is mixed with an oscillating signal supplied from a second local oscillating circuit 48 and is then frequency-converted into a third intermediate frequency signal. The second mixing circuit 47 and the second local oscillating circuit 48 constitute a second frequency converting circuit 49.

Here, the frequency of the third intermediate frequency signal is different for each program to be transmitted, and the oscillation frequency of the second local oscillating circuit 48 is set such that the frequency of the third intermediate frequency signal is matched to any one of frequencies of the respective channels set approximately in the range of 50 MHz to 1 GHz. Further, the third intermediate frequency signal output from the second mixing circuit 47 is amplified by a predetermined gain in the third intermediate frequency amplifying circuits 50 and 51, and is then transmitted to a cable (not shown) through a band pass filter 52 and an output amplifying circuit 53 (for example, see Japanese Unexamined Patent Application Publication No. 10-304257 (FIG. 6)).

In the above-mentioned television signal transmitter, it is general that the first frequency converting circuit 44 and the second frequency converting circuit 49 are provided with PLL circuits, respectively, and that the first oscillating circuit 43 and the second oscillating circuit 48 are frequency-controlled by the respective PLL circuits. Further, it is necessary that the frequencies of the second and third intermediate frequency signals be converted at steps of 12.5 KHz and 250 KHz, respectively. Accordingly, a comparison frequency of the PLL circuit of the first frequency converting circuit 44 is set to 12.5 KHz, and a comparison frequency of the PLL circuit of the second frequency converting circuit 49 is set to 250 KHz.

As described above, since the comparison frequencies of the PLL circuits are as low as below several hundred KHz, the phase noise of the output signal (the third intermediate frequency signal) is increased over the entire band.

Moreover, since the comparison frequencies of the two PLL circuits are different from each other, the phase noise has a concavo-convex shape, as indicated by a curve A in FIG. 2. As a result, the phase noise increases in a part of the band.

### SUMMARY OF THE INVENTION

The present invention is designed to solve the above-mentioned problems, and it is an object of the present invention to provide a television signal transmitter capable of reducing a phase noise.

In order to achieve the above object, according to a first aspect of the present invention, a television signal transmitter comprises a first frequency conversion unit for up-converting a first intermediate frequency signal modulated by an image signal and a voice signal into a second intermediate frequency signal; and a second frequency conversion unit for down-converting the second intermediate frequency signal into a television channel signal, wherein the first frequency conversion unit is provided with a first local oscillating circuit and a first PLL circuit for controlling an oscillating frequency of the first local oscillating circuit, the second frequency conversion unit is provided with a second local oscillating circuit and a second PLL circuit for controlling an oscillating frequency of the second local oscillating circuit, and the first PLL circuit and the second PLL circuit each are constituted by a fractional PLL circuit.

Further, according to a second aspect of the invention, the comparison frequencies of the first and second PLL circuits are equal to each other.

Furthermore, according to a third aspect of the invention, a reference signal having a predetermined frequency is output from a reference oscillating circuit common to the first and second PLL circuits and is then input to the first and second PLL circuits, respectively, and the frequency of the reference signal is the comparison frequency.

Moreover, according to a fourth aspect of the invention, the frequency of the reference signal is 20 MHz.

In the television signal transmitter according to the first aspect, the first frequency conversion unit is provided with the first local oscillating circuit and the first PLL circuit for controlling the oscillating frequency of the first local oscillating circuit, the second frequency conversion unit is provided with the second local oscillating circuit and the second PLL circuit for controlling the oscillating frequency of the second local oscillating circuit, and the first PLL circuit and the second PLL circuit are constituted by fractional PLL circuits, respectively, so that it is possible to make the comparison frequency of a phase shifter in each of the PLL circuits higher than a step frequency of each of the local oscillating circuits. As a result, the phase noises output from the respective local oscillating circuits can be reduced.

Further, in the television signal transmitter in accordance with the second aspect of the invention, the comparison frequencies of the first and second PLL circuits are equal to each other, so that the phase noise has a characteristic of monotonically decreasing at a level lower than that in the related art. As a result, the phase noise can be further reduced without being increased in a specific frequency band.

Furthermore, in the television signal transmitter according to the third aspect of the invention, the reference signal having a predetermined frequency is output from the reference oscillating circuit common to the first and second PLL circuits and is then input to the first and second PLL circuits, respectively, and the frequency of the reference signal is set to the comparison frequency, so that it is possible to make the comparison frequencies of the respective PLL circuits equal to each other by using one reference oscillating circuit.

Moreover, in the television signal transmitter according to the fourth aspect of the invention, the frequency of the reference signal is 20 MHz, so that the reference oscillating circuit and the phase comparator circuits of the respective PLL circuits can be operated without any trouble.

### BRIEF DESCRIPTION OF THE DRAWINGS

FIG. 1 is a circuit diagram illustrating the configuration of a television signal transmitter according to the present invention;

FIG. 2 is a view illustrating characteristics of a phase noise in the television signal transmitter; and

FIG. 3 is a circuit diagram illustrating the configuration of a conventional television signal transmitter.

### DESCRIPTION OF THE PREFERRED EMBODIMENT

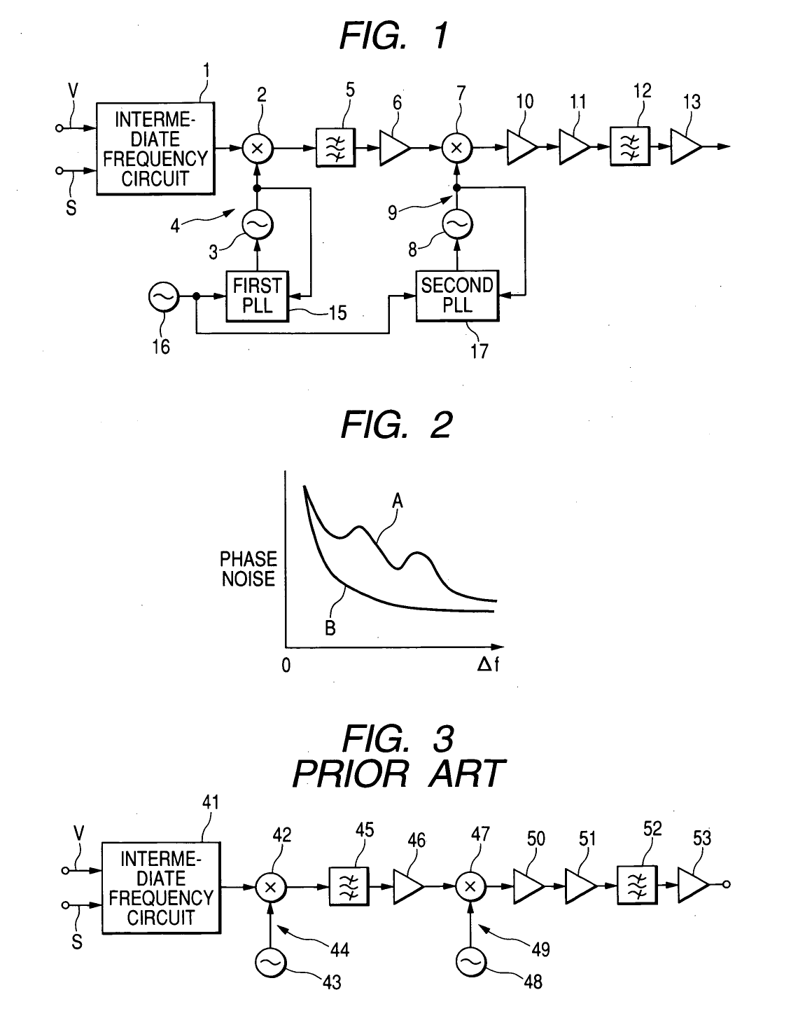

FIG. 1 illustrates the configuration of a television signal transmitter according to the present invention. In FIG. 1, an image signal V and a voice signal S are input to an intermediate frequency circuit 1, and an intermediate frequency signal (a first intermediate frequency signal having a frequency of 45.75 MHz) modulated by the image signal V and voice signal S is output from the intermediate frequency circuit 1 and is then input to a first mixing circuit (mixer) 2. Here, the first intermediate frequency signal is mixed with an oscillating signal supplied from a first local oscillating circuit 3 and is then frequency-converted (up-converted) into a second intermediate frequency signal having a frequency of about 1.3 GHz. The first mixing circuit 2 and the first local oscillating circuit 3 constitute a first frequency conversion unit 4.

The oscillation frequency of the first local oscillating circuit 3 is controlled by a first PLL circuit 15. The first PLL circuit 15 is constituted by a fractional PLL circuit. Specifically, although not shown, the first PLL circuit 15 is provided with a programmable counter composed of a prescaler and a dual modulus prescaler, a fractional control unit, a phase comparator circuit, and a loop filter, and the like. In addition, a reference signal, having a frequency of 20 MHz, output from a reference oscillating circuit 16 is directly (without any frequency multiplication/division) input to the phase comparator circuit and the fractional control unit. Accordingly, the comparison frequency of the phase comparator circuit becomes the frequency of the reference signal. Further, the local oscillating signal output from the first local oscillating circuit 3 is converted at, for example, a step of 12.5 KHz, by the fractional control unit and the programmable counter. In this way, when using the fractional PLL circuit, the oscillating frequency can be converted into a step frequency lower than the comparison frequency, regardless of the magnitude of the comparison frequency.

The second intermediate frequency signal output from the first mixing circuit 2 passes through a band pass filter 5 having a predetermined bandwidth (approximately 6 MHz), then is amplified to a predetermined level by a second intermediate frequency amplifying circuit 6, and then is input to a second mixing circuit 7. In the second mixing circuit 7, the second intermediate frequency signal is mixed with an oscillating signal supplied from a second local oscillating circuit 8 and is then frequency-converted into a third intermediate frequency signal. The third intermediate frequency signal becomes a signal of television channels each having a frequency of 50 MHz to 1 GHz. Accordingly, the second intermediate frequency signal is down-converted. The second mixing circuit 7 and the second local oscillating circuit 8 constitute a second frequency converting circuit 9.

The oscillation frequency of the second local oscillating circuit 8 is controlled by a second PLL circuit 17. In the same manner as in the first PLL circuit 15, the second PLL circuit 17 is also constituted by a fractional PLL circuit. Although not shown, the second PLL circuit 17 is provided with a programmable counter composed of a prescaler and a dual modulus prescaler, a fractional control unit, a phase comparator circuit, and a loop filter, and the like. Moreover, the reference signal, having a frequency of 20 MHz, output from the reference oscillating circuit 16 is directly (without any frequency multiplication/division) input to the phase comparator circuit and the fractional control unit. Accordingly, the comparison frequency of the phase comparator circuit becomes the frequency of the reference signal. Further, the local oscillating signal output from the second local oscillating circuit 8 is converted at, for example, a step of 250 KHz, by the fractional control unit and the programmable counter. In this way, when using the fractional PLL circuit, the oscillating frequency can be converted into a step frequency lower than the comparison frequency, regardless of the magnitude of the comparison frequency.

Here, the frequency of the third intermediate frequency signal is different for each program to be transmitted, and the oscillation frequency of the second local oscillating circuit 8 is set such that the frequency of the third intermediate frequency signal is matched to any one of frequencies of the respective channels set approximately in the range of 50 MHz to 1 GHz. Further, the third intermediate frequency signal output from the second mixing circuit 7 is amplified by a predetermined gain in the third intermediate frequency amplifying circuits 10 and 11, and is then transmitted to a cable (not shown) through a band pass filter 12 and an output amplifying circuit 13.

As such, the first and second PLL circuits 15 and 17 are all constituted by the fractional PLL circuits, so that it is possible to make the comparison frequency higher than the step frequency of the respective local oscillating circuits 3 and 8. As a result, the phase noise output from the respective local oscillating circuits 3 and 8 is reduced. In addition, by making the comparison frequencies of the phase comparator circuits of the respective PLL circuits 15 and 17 equal to each other, the phase noise has a characteristic of monotonically decreasing at a level lower than that in the related art, as indicated by a curve B in FIG. 2, so that the phase noise is not increased in a specific frequency band.

Further, the higher the comparison frequencies of the PLL circuits 15 and 17 are, the more the phase noise is reduced. However, considering the relationship between the operation threshold frequencies of the phase comparator circuits of the PLL circuits 15 and 17 and the fact that a crystal oscillator is used in the reference oscillating circuit 16, the comparison frequencies are preferably set to about 20 MHz.

1. A television signal transmitter comprising:
a first frequency conversion unit for up-converting a first intermediate frequency signal modulated by an image signal and a voice signal into a second intermediate frequency signal; and
a second frequency conversion unit for down-converting the second intermediate frequency signal into a television channel signal,
wherein the first frequency conversion unit is provided with a first local oscillating circuit and a first PLL circuit for controlling an oscillating frequency of the first local oscillating circuit,
the second frequency conversion unit is provided with a second local oscillating circuit and a second PLL circuit for controlling an oscillating frequency of the second local oscillating circuit, and
the first PLL circuit and the second PLL circuit each are constituted by a fractional PLL circuit.

2. The television signal transmitter according to claim 1,
wherein a comparison frequency of the first PLL circuit and a comparison frequency of the second PLL circuit are equal to each other.

3. The television signal transmitter according to claim 2,
wherein a reference signal having a predetermined frequency is output from a reference oscillating circuit common to the first and second PLL circuits and is then input to the first and second PLL circuits, respectively, and,
the frequency of the reference signal is set to the comparison frequency.

4. The television signal transmitter according to claim 3,
wherein the frequency of the reference signal is 20 MHz.
